(19) United States
(12) Patent Application Publication
(10) Pub. No.: US 2026/0320308 A1
(43) Pub. Date: Oct. 15, 2026

(54) AUTONOMOUS PLATFORM FOR PRODUCT DESIGN AND OPTIMIZATION USING LARGE LANGUAGE MODELS AND EVOLUTIONARY ALGORITHMS

(71) Applicant: Polaron Analytics, Miamisburg, OH (US)

(72) Inventors: Duy Nhat Phan, Dayton, OH (US); Rahul Bhowmik, Centerville, OH (US)

(21) Appl. No.: 19/465,873

(22) Filed: Jan. 30, 2026

Related U.S. Application Data
(60) Provisional application No. 63/752,450, filed on Jan. 31, 2025.

(51) Int. Cl. G06F 40/40

(52) U.S. Cl. CPC G06F 40/40

(57) ABSTRACT

A process for generating a novel solution comprises receiving a request for a solution and receiving data (including training data) corresponding to the problem. The request and data are received via a user interface. A loop performs until a stopping condition is met. The loop includes: creating a prompt for a large language model (LLM) to generate a new solution to the problem; evaluating a performance of the generated solution; decide whether to prompt the LLM to mutate the generated solution; if the decision is to mutate the generated solution, mutate the generated solution, evaluate the performance of the mutated generated solution, and store the mutated generated solution; if the decision is not to mutate the generated solution, store the generated solution. After the stopping condition is met, the process determines a best solution from the stored solutions and presents the best solution to the user via the user interface.

### CROSS REFERENCE TO RELATED APPLICATIONS

This application claims the benefit of U.S. Provisional Patent Application Ser. No. 63/752,450, filed Jan. 31, 2025, having the title AUTONOMOUS PLATFORM FOR PRODUCT DESIGN AND OPTIMIZATION USING LARGE LANGUAGE MODELS AND EVOLUTIONARY ALGORITHMS, by Duy Nhat Phan et al., the entire disclosure of which is hereby incorporated herein by reference.

### BACKGROUND

Various aspects of the present disclosure relate generally to machine learning and in particular to machine learning to develop new solutions and optimizations for product design.

Many fields require systems that combine advanced technical capabilities with accessibility, enabling both experts and non-experts to tackle complex problems effectively. For example, chemists working on materials design, such as creating low-flammability substances, may lack computer science expertise. They require tools that simplify the process by providing intuitive insights, simulations, and comparisons. These systems must go beyond generating actionable results as they need to adapt to evolving requirements, integrate new datasets, and incorporate user feedback. For instance, tasks like comparing new materials to existing ones, refining properties, and updating models to reflect current advancements require continuous improvement.

### BRIEF SUMMARY

According to aspects of the present disclosure, a process for generating a novel solution to an issue requested by a user comprises receiving a request for a solution identified in the request and receiving training data (and possibly other information including initial solutions) corresponding to the problem, wherein the request and the training data are received via a user interface. A loop performs until a stopping condition is met, and the loop includes: (1) creating a prompt for a large language model (LLM) to generate a new solution to the problem; (2) evaluating the performance of the generated solution; (3) with a predefined probability, deciding whether to prompt the LLM to mutate the generated solution; (4) if the decision is to prompt the LLM to mutate the generated solution, mutate the generated solution; evaluate the performance of the mutated generated solution; and store the mutated generated solution; (5) if the decision is not to prompt the LLM to mutate the generated solution, store the generated solution. After the stopping condition is met, the process determines a best solution from the stored solutions and presents the best solution to the user via the user interface.

### BRIEF DESCRIPTION OF THE SEVERAL VIEWS OF THE DRAWINGS

FIG. 1 is a block diagram of a platform for generating novel solutions to a user query, according to various aspects of the present disclosure;

FIGS. 2A-B is a flow chart illustrating a process for generating novel solutions to a user query, according to various aspects of the present disclosure; and

FIG. 3 is a block diagram of a computing system for operating the platform, the process, or both, according to various aspects of the present disclosure.

### DETAILED DESCRIPTION

According to aspects described herein, a platform is provided that aids in product design and optimization by integrating advanced large language models (LLMs) and evolutionary algorithms. The platform provides a natural language chatbot interface that allows users to articulate complex requirements and receive tailored, high-performance solutions across various domains. By harnessing the power of LLMs, the platform enables intuitive interaction, automating the generation of advanced artificial-intelligence/machine-learning algorithms, mathematical models, materials, and more. The evolutionary algorithms embedded within the platform continuously refine the solutions, ensuring adaptability to evolving needs and stringent performance criteria.

In addition to solution generation, the platform supports fine-tuning LLMs for domain-specific tasks, automates the management of comprehensive knowledge repositories, and offers secure, local operation to ensure data confidentiality. The platform's adaptability allows the platform to autonomously refine and recommend solutions in response to new data or threats, making it an indispensable tool for industries and governments seeking to tackle complex challenges.

### Platform

The platform includes a user interface, e.g., a chatbot. The interface acts as a primary point of interaction between a user and the platform, enabling the user to articulate requirements (e.g., a problem) in a natural language. Thus, users can upload initial solutions for refinement by the platform, provide datasets for evaluating solutions generated by the platform, ask for new solutions tailored to their specific needs, or combinations thereof. Additionally, the user interface allows users to execute generated solutions in code format, modify the generated solutions, offer feedback, or combinations thereof. By facilitating intuitive interaction, the interface makes the platform accessible to both technical and non-technical users, simplifying the process of solution generation and refinement.

The platform uses a fine-tuned or pretrained large language model (LLM) to process the user inputs to generate prompts for the user and to produce context-aware solutions aligned with the user's requirements. The LLM is trained on domain-specific data and ensures high relevance and accuracy, generating actionable outputs in various formats, such as code snippets or textual descriptions. Further, the platform includes a prompt module to enhance a quality of outputs from the LLM by translating user inputs and feedback into structured prompts optimized for processing by the LLM. The prompt module continuously refines the prompts to the user based on feedback from users (including a current user) and an evaluation module, which ensures that the generated solutions meet performance criteria identified by the user. Thus, the prompt module bridges a gap between user requirements and processing capabilities of the LLM, enhancing precision and relevance of the generated outputs.

Moreover, the platform integrates an evolutionary algorithm with LLM to refine and optimize the solutions generated by the LLM. The evolutionary algorithm applies iterative techniques such as mutation, crossover, and selection to improve the quality and performance of the generated solutions. By autonomously adapting solutions to evolving requirements and datasets, the evolutionary algorithm ensures continuous optimization and alignment with user-defined goals, minimizing the need for manual intervention.

Also, the platform includes a solution generator, which serves as an integration point between the LLM and the evolutionary algorithm by combining outputs from the LLM and the evolutionary algorithm to produce finalized solutions that are ready for execution or further modification by the user.

As mentioned above, the platform also includes the evaluation module that rigorously assesses the quality and performance of the generated solutions. Using user-uploaded datasets and predefined metrics, the evaluation module tests the solutions and provides actionable feedback to other components, such as the evolutionary algorithm and the prompt module. By creating a continuous cycle of evaluation and improvement, the platform ensures that its outputs align with user expectations and meet the highest standards of quality.

Further, the platform incorporates a feedback loop that integrates user evaluations and suggestions into the solution generation and refinement processes. The feedback loop enables the platform to adapt dynamically to new data, evolving requirements, and changing user needs. By continuously learning from user interactions, the platform evolves to provide increasingly effective and customized solutions.

The real-time feedback loop that allows users to evaluate outputs and provide direct input for refinement. This feedback is integrated into a solution generation process, enabling the platform to learn and improve with each iteration. By incorporating user evaluations, the system ensures that the outputs are not only technically sound but also aligned with user expectations and preferences.

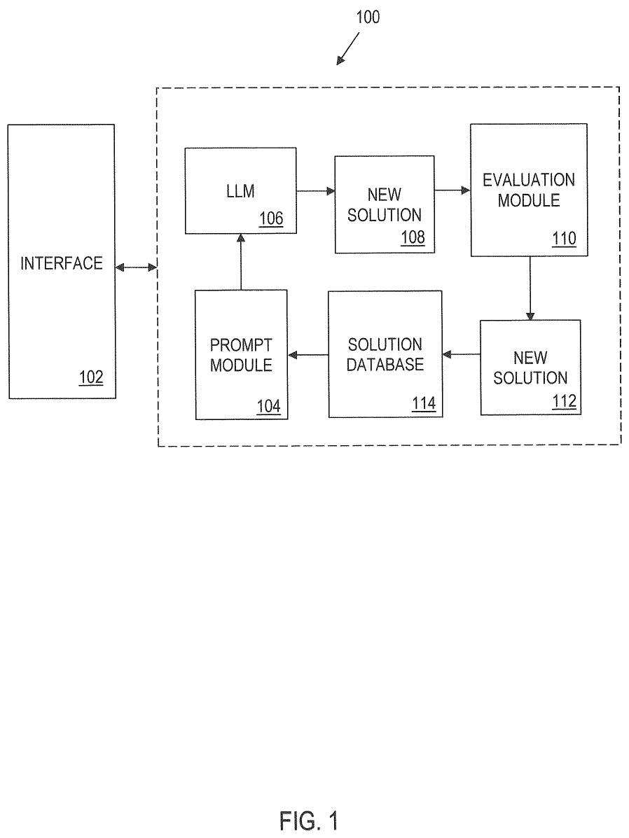

Turning to FIG. 1, a block diagram of the platform 100 is shown. As discussed above, the platform couples to a user interface 102 in the form of a chatbot. A user can enter requests for a solution, training data sets, an initial solution, anything else that may help the platform come up with a solution, or combinations thereof. Moreover, the requests may be written in a plain language, so the user is not required to be technically adept in the solution the user is requesting. For example, a user request may look like this: “Generate a new polymer structure with low flammability.” The request is then turned into a prompt by a prompt module 104.

By using a fine-tuned large language model (LLM) 106 on domain-specific data, the LLM 106 ensures high relevance and accuracy, generating actionable outputs in various formats, such as code snippets or textual descriptions. The LLM 106 generates a new solution 108, which is fed to an evaluation module 110. The evaluation module 110 determines a fitness score for the new solution 108 by running the module with training data supplied by the user. In some instances, the evaluation module sends the new solution 108 (or a newly generated solution 112) to a solution database 114 along with the fitness score for later use. Further, the evaluation module may indicate that a mutation of the new solution (or a different solution) should occur. If so, the prompt module 104 creates a new prompt for the LLM 106. The LLM 106 then starts the loop through the platform 100 again with the new prompt from the prompt module 104. Once a stopping condition is met, the solution with the best fitness score is presented to the user via the user interface 102. The user may also execute a generated solution via the user interface as well as manually modify the generated solution if desired. Further, the user may provide feedback in general through the user interface 102.

### Process

A process performed by the platform includes an input phase where users interact with the platform via a user interface (e.g., a natural language chatbot interface). Users can upload datasets for evaluation, provide initial solutions to be refined, specify requirements for generating new solutions, or combinations thereof. The chatbot enables users to articulate their needs in plain language. Additionally, users can modify solutions and provide feedback directly within the user interface, creating a dynamic, user-driven interaction loop.

Once inputs are received from the user via the user interface, the platform transitions to the processing phase, where multiple components work together to generate and refine solutions. The fine-tuned or pretrained large language model (LLM) interprets the inputs and generates initial solutions based on the LLM's extensive knowledge base and training data or retrieves initial solutions from the existing solution database (e.g., a library of solutions). These solutions are further refined by the evolutionary algorithm module, which applies iterative optimization techniques, such as mutation and selection, to ensure the generated outputs meet performance criteria and align with user-defined goals. The platform continuously integrates feedback from users and the evaluation module to refine its outputs further, making the process highly adaptive.

Once one or more solutions meet performance criteria, the platform enters an output phase, delivering actionable, high-quality solutions tailored to the user's requirements. These outputs may include optimized algorithms, material designs, code snippets, or combinations thereof, that are ready for execution or further modification. Users can test, execute, or refine these solutions within the platform, ensuring seamless integration into the users'workflows. The platform also stores generated solutions in a repository, enabling easy access for future use, iterative improvements, or both.

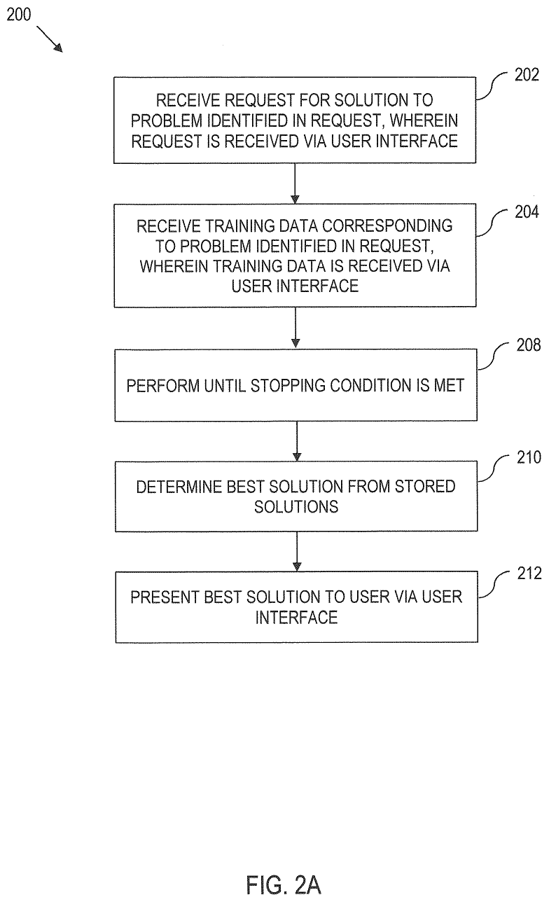

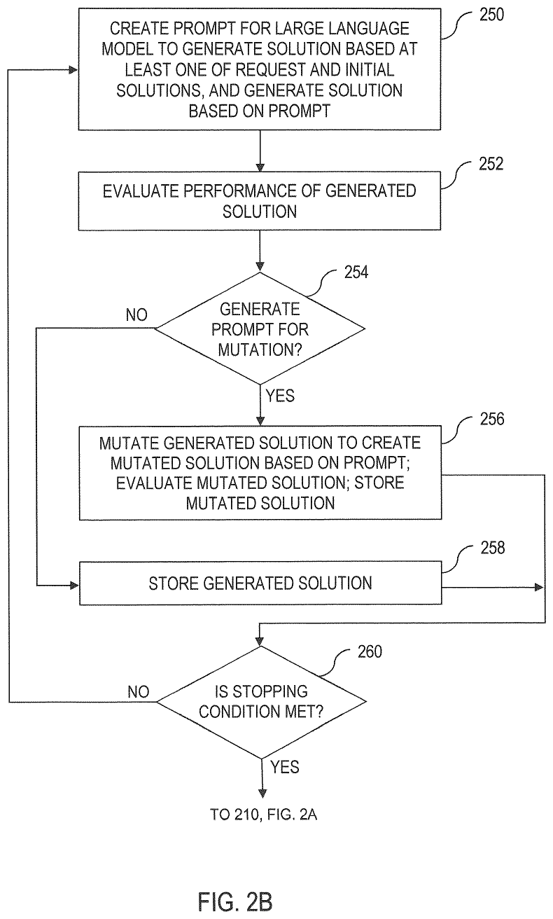

Turning to FIGS. 2A-B, a process 200 for generating a novel solution to an issue (e.g., a product design issue) requested by a user is shown. At 202, a request for a solution to a problem identified in the request is received via a user interface. For example, a user may type a prompt into a chatbot using natural language. In some embodiments, the request also includes an initial solution to the problem. For example, if the problem is to define a new neural network, the user may supply an initial model of a neural network. At 204, training data corresponding to the problem identified in the request is received via a user interface.

At 208, a loop is performed for several iterations until a stopping condition is met, as will be discussed herein. Once the stopping condition is met, at 210, a best solution is determined from results of each iteration through the loop, and at 212, the solution is presented to the user via the user interface, where the user can execute the solution, modify the solution, provide feedback on the solution, or combinations thereof.

Regarding the iteration loop at 208, at 250, a prompt for a large language model to generate a solution based at least one the request and initial solutions is created, and a solution based on the prompt is generated. The solution is generated by an LLM.

At 252, a performance of the generated solution is evaluated. At 254, based on a predetermined probability, a decision is made whether or not to create a prompt for the LLM to mutate the generated solution. If the decision is to mutate the generated solution, then at 256, then the LLM mutates the generated solution to generate a mutated solution, the mutated solution is evaluated and stored in a database (along with the evaluation results (e.g., a fitness score)). As discussed herein, generating the prompt to mutate the solution may include accessing a library of solutions.

If the decision is not to mutate the generated solution, then at 258 the generated solution is stored in the database with the evaluation results (including a fitness score). At 260, if a stopping condition is met, the process proceeds to 210. However, if the stopping condition is not met, then the process loops back to 250 for another pass through the iteration.

### Example #1: Novel Neural Network Design

The platform streamlines the design of novel neural networks by combining user interaction, automated generation, iterative mutation, and rigorous evaluation. Example #1 illustrates how the platform autonomously creates optimized neural network architectures tailored to user needs and datasets.

The process begins with the user interacting with the platform through its natural language chatbot interface. For example, the user queries: “Generate a new neural network for my dataset.” The platform initiates the process by accessing a model database, which stores a variety of initial neural network architectures along with their performance metrics. In this example, four existing models are available.

### Model 1: A Simple Linear Architecture.

import torch
import torch.nn as nn
import torch.nn.functional as F
class Model(nn.Module):
   def_init_(self, output_size, input_size=40):
      super(Model, self)._init_( )
      self.linear=nn.Linear(input_size, output_size)
   def forward(self, x):
      return self.linear(x)

### Model 2: A Feedforward Network With Skip Connections.

import torch
import torch.nn as nn
import torch.nn.functional as F
class Model(nn.Module):
   def_init_(self, output_size, input_size=40, hidden_size=100):
      super(Model, self)._init_( )
      self.linear1=nn.Linear(input_size, hidden_size)
      self.linear2=nn.Linear(hidden_size, hidden_size)
      self.linear3=nn.Linear(hidden_size, output_size)
   def forward(self, x):
      h=self.linear1(x).relu( )
      h=h+self.linear2(h).relu( )
      return self.linear3(h)

### Model 3: A GRU-Based Recurrent Neural Network for Time-Series Data.

import torch
import torch.nn as nn
import torch.nn.functional as F
class Model(nn.Module):
   def_init_(self, output_size, input_size=1, hidden_size=6, time_steps=40):
      super(Model, self)._init_( )
      bidirectional=True
      self.gru=torch.nn.GRU(input_size=input_size, hidden_size=hidden_size, batch_first=True, bidirectional=bidirectional)
      flat_size=2*hidden_size*time_steps if bidirectional else hidden_size*time_steps
      self.linear=torch.nn.Linear(flat_size, output_size)
      self.hidden_size=hidden_size
      self.bidirectional=bidirectional
   def forward(self, x, h0=None): #assumes seq has [batch, time]
      x=x.view(*x.shape[:2], 1) #add a spatial dimension
      k=2 if self.bidirectional else 1
      h0=0*torch.randn(k, x.shape[0], self.hidden_size) if h0 is None else h0
      output, hn=self.gru(x, h0)
      output=output.reshape(output shape[0],−1) #[batch, time*hidden_size]
      return self.linear(output)

### Model 4: A Convolutional Neural Network Optimized for Feature Extraction.

import torch
import torch.nn as nn
import torch.nn.functional as F
class Model(nn.Module):
   def_init_(self, output_size, channels=25, linear_in=125):
      super(Model, self)._init_( )
      self.conv1=nn.Conv1d(1, channels, 5, stride=2, padding=1)
      self.conv2=nn.Conv1d(channels, channels, 3, stride=2, padding=1)
      self.conv3=nn.Conv1d(channels, channels, 3, stride=2, padding=1)
      self.linear=nn.Linear(linear_in, output_size)
   def forward(self, x, verbose=False): #the print statements are for debugging
      x=x.view(−1,1,x.shape[−1])
      h1=self.conv1(x).relu( )
      h2=self.conv2(h1).relu( )
      h3=self.conv3(h2).relu( )
      h3=h3.view(h3.shape[0],−1) #flatten the conv features
      return self.linear(h3) #a linear classifier goes on top

Note that the user also can upload their own initial neural network models.

At each iteration, the platform randomly selects two models with their fitness scores (e.g. classification accuracy). The better-performing model is identified, and the platform prompts the LLM to generate a new neural network. For instance, the LLM receives the following prompt generated by the platform based on an input from the user: “Given a dataset, you have two neural network architectures, as below. Model 2 is the better one. Please provide a better new neural network architecture. Provide only one Python class called Model, without any explanation or words. Model 1: . . . Model 2: . . . .”

The LLM generates a new Python class representing a neural network architecture as a model. The platform then evaluates this generated model on the user-uploaded dataset and produces a fitness score. Using a probability, the platform decides whether to prompt the LLM to mutate the architecture (model) further. Mutation is triggered using the following prompt generated by the platform: “Modify the neural network architecture to make the following model reasonable without changing the input and output. Provide only one Python class called Model, without any explanation or words. Model 1: . . . Model 2: . . . .”

The platform modifies the model, which is re-evaluated and stored in the model database along with a modified fitness score. This iterative process continues, refining models and improving their performance over time. After completing a specified number of iterations (e.g., 100, customizable by the user), the platform analyzes all generated models and recommends the best-performing architecture. This model, which has been optimized through evaluation, mutation, and crossover, is presented to the user as the final output. The entire process is autonomous, reducing manual effort while leveraging the platform's ability to generate and refine state-of-the-art neural networks.

### Example #2: Group Recommendation Algorithm Design

The platform simplifies the creation of group recommendation algorithms by combining user input, automated generation, iterative refinement, and rigorous evaluation. Example #2 demonstrates how the platform autonomously develops novel preference aggregation strategies tailored to a user-uploaded rating matrix for items.

The example begins with the user uploading a rating matrix for a group of users and items to the platform through the natural language chatbot interface. The user queries: “Develop a new group recommendation algorithm based on this dataset.” In response, the platform accesses a library of initial aggregation algorithms (solutions), see the five algorithms below:

### Algorithm 1:

import numpy as np
def group_score(user_item_rating_matrix):
score=user_item_rating_matrix.mean(axis=0)
return score

### Algorithm 2:

import numpy as np
def group_score(user_item_rating_matrix):
#A trade-off parameter
lamb=0.5
#number of users
m=user_item_rating_matrix.shape[0]
#Get average score of the group
average_score=user_item_rating_matrix.mean(axis=0)
#Get the average pair-wise agreement for the items
pair_wise_agreement=0
for i in range(m):
for j in range(i+1,m):
pair_wise_agreement=np.abs(user_item_rating_matrix[i,:]−user_item_rating_matrix[j,:])
pair_wise_agreement=pair_wise_agreement*2/(m*(m−1))
#Get a linear combination of average score and average pair-wise disagreement
score=lamb*average_score+(1−lamb)*(1−pair_wise_agreement)
return score

### Algorithm 3:

import numpy as np
def group_score(user_item_rating_matrix):
#number of users
m, n=user_item_rating_matrix.shape
point_matrix=np.zeros((m,n))
#Get individual points
for i in range(m):
point_matrix[i,:][np.argsort(user_item_rating_matrix[i,:])]=np.array(range(n))
#Get sum score of the group
score=point_matrix.sum(axis=0)
return score

### Algorithm 4:

import numpy as np
def group_score(user_item_rating_matrix):
#Get group scores
score=np.prod(user_item_rating_matrix, axis=0)
return score

### Algorithm 5:

import numpy as np
def group_score(user_item_rating_matrix):
#Get group scores
score=np.min(user_item_rating_matrix, axis=0)
return score

At each iteration, the platform evaluates the existing aggregation strategies using a fitness metric such as the relevance or satisfaction score derived from the uploaded data. It then selects two strategies for comparison based on their fitness scores. The better-performing strategy is used to guide the creation of a new aggregation algorithm. For instance, the platform prompts the large language model (LLM) with the following request: “Given a rating matrix and two aggregation strategies as below, where Algorithm 2 performs better than Algorithm 1, provide a new and improved aggregation strategy. Return only one Python function definition called group_score, without any explanation or additional text. Algorithm 1: . . . Algorithm 2: . . . .”

The LLM generates a new Python algorithm representing the aggregation strategy. The platform evaluates the new algorithm using the uploaded rating matrix. Additionally, with a certain probability, the platform triggers a mutation phase to refine the generated new algorithm. As above, a prompt is given to the LLM: “Without altering the input and output structure, modify the following group recommendation algorithm to make it more effective. Provide only one Python function definition called group_score, without any explanation or additional text.”

The platform performs a mutation of the algorithm to generate a mutated algorithm, which undergoes evaluation and is saved in the platform's database alongside a performance score. This iterative process of comparison, generation, evaluation, and mutation continues, allowing the platform to refine its strategies progressively.

After a number of iterations (e.g., a predetermined number, a number received from the user) the platform analyzes all generated algorithms and recommends the generated algorithm with the highest fitness score, which is presented to the user as the most effective group recommendation solution based on the given dataset.

Example #2 highlights the platform's ability to autonomously innovate and optimize group recommendation algorithms. By leveraging advanced natural language interaction and iterative refinement, the platform reduces the time and effort required to design sophisticated aggregation strategies while ensuring superior performance tailored to user data.

### Example #3: Algorithm Design for Finding Key Nodes in a Network

Example #3 demonstrates how the platform autonomously develops optimized algorithms tailored to identify key nodes in an uploaded network edge matrix. The process begins when a user uploads a network edge matrix and interacts with the platform via the natural language chatbot interface. For instance, the user requests: “Develop an algorithm to find the key nodes in this network.” The platform initiates the process by referencing a database of initial algorithms:

### Algorithm 1:

import numpy as np
def score_nodes(adjacency_matrix):
degrees=np.sum(adjacency_matrix, axis=1)
scored_nodes={ }
for node_id, degree in enumerate(degrees):
scored_nodes[node_id]=degree
return scored_nodes

### Algorithm 2:

import networkx as nx
def score_nodes(adjacency_matrix):

G=nx.Graph(adjacency_matrix)
betweenness=nx.betweenness_centrality(G)
return betweenness

### Algorithm 3:

import numpy as np
def score_nodes(adjacency_matrix):
eigenvalues, eigenvectors=np.linalg.eig(adjacency_matrix)
max_eigenvalue_index=np.argmax(eigenvalues)
eigenvector=eigenvectors[:, max_eigenvalue_index]
normalized_eigenvector=eigenvector/np.sum(eigenvector)
scored_nodes={ }
for node_id, centrality_score in enumerate(normalized_eigenvector):
scored_nodes[node_id]=centrality_score
return scored_nodes

### Algorithm 4:

import numpy as np
def score_nodes(adjacency_matrix):
num_nodes=adjacency_matrix.shape[0]
clustering_coefficients=np.zeros(num_nodes)
for node in range(num_nodes):
neighbors=np.where(adjacency_matrix[node]==1)[0]
num_neighbors=len(neighbors)
if num_neighbors<2:
clustering_coefficients[node]=0.0
else:
num_connected_pairs=0
for i in range(num_neighbors):
for j in range(i+1, num_neighbors):
if adjacency_matrix[neighbors[i], neighbors[j]]==1:
num_connected_pairs+=1
clustering_coefficients[node]=(2.0*num_connected_pairs)/(num_neighbors*(num_neighbors−1))
scored_nodes={node_id: clustering_coefficients[node_id] for node_id in range(num_nodes)}
return scored_nodes

### Algorithm 5:

import numpy as np
def score_nodes(adjacency_matrix):
node_degree_map=np.sum(adjacency_matrix, axis=0)
num_nodes=adjacency_matrix.shape[0]
node_ci=np.zeros(num_nodes)
scored_nodes={ }
for node in range(num_nodes):
ci=0
neighbors=np.where(adjacency_matrix[node]==1)[0]
for neighbor in neighbors:
ci+=(node_degree_map[neighbor]−1)
node_ci[node]=ci*(node_degree_map[node]−1)
scored_nodes[node]=node_ci[node]
return scored_nodes“″”,
“″”import networkx as nx
def score_nodes(adjacency_matrix):
G=nx.Graph(adjacency_matrix)
scored_nodes=nx.pagerank(G)
return scored_nodes

### Algorithm 6:

import networkx as nx
def score_nodes(adjacency_matrix):
G=nx.Graph(adjacency_matrix)
scored_nodes=nx.percolation_centrality(G)
return scored_nodes

### Algorithm 7:

import networkx as nx
def score_nodes(adjacency_matrix):
G=nx.Graph(adjacency_matrix)
scored_nodes=nx.harmonic_centrality(G)
return scored_nodes

### Algorithm 8:

import networkx as nx
import numpy as np
from scipy.sparse.linalg import eigsh
def score_nodes(adjacency_matrix):
G=nx.Graph(adjacency_matrix)
LCC=G. subgraph(max(nx.connected_components(G), key=len))
ii={v: i for i, v in enumerate(LCC.nodes( ))}
L=nx.normalized_laplacian_matrix(LCC)
eigenvalues, eigenvectors=eigsh(L.astype(np.float32), k=2, which=‘SM’, maxiter=1000*L.shape[0])
Fiedler=eigenvectors[:, 1]
H=nx.Graph([(u, v) for u, v in LCC.edges( ) if Fiedler[ii[u]]*Fiedler[ii[v]]<=0.0])
for v in H.nodes( ):
H.nodes[v][‘weight’]=1.0/H.degree(v)
cover=list(nx.algorithms.approximation.min_weighted_vertex_cover(H, weight=‘weight’))
max_degree=max([G.degree(v) for v in G.nodes( ) if v not in cover])
min_weight=min(H.nodes[v][‘weight’] for v in H.nodes( ))
scored_nodes={v: H.nodes[v][‘weight’] if v in cover else G.degree(v)/max_degree*min_weight for v in G.nodes( )}
return scored_nodes

### Algorithm 9:

import networkx as nx
def score_nodes(adjacency_matrix):
G=nx.Graph(adjacency_matrix)
score 1={node_id: 0.0 for node_id in G.nodes( )}
for u, v in G.edges( ):
degree_u=G.degree(u)
degree_v=G.degree(v)
score 1[u]+=1.0/degree_u if degree_u !=0 else 0.0
score 1[v]+=1.0/degree_v if degree_v !=0 else 0.0
betweenness=nx.betweenness_centrality(G)
pagerank=nx.pagerank(G)
weight_degree=0.2
weight_betweenness=0.3
weight_pagerank=0.5
scored_nodes={ }
for node_id in G.nodes( ):
score=(weight_degree*score 1.get(node_id, 0)+
weight_betweenness*betweenness[node_id]+
weight_pagerank*pagerank[node_id])
scored_nodes[node_id]=score
return scored_nodes

At each iteration, the platform randomly selects two algorithms from the database along with their fitness scores (e.g., the accuracy of identifying critical nodes or alignment with user-defined criteria). The better-performing algorithm is used to guide the generation of a new algorithm through the LLM. For example, the LLM uses a prompt like “Given a network edge matrix, you have two algorithms as below. Algorithm 2 performs better than Algorithm 1. Provide a new and improved algorithm for finding key nodes in the network. Return only one Python function definition called score_nodes, without any explanation or additional text. Algorithm 1: . . . Algorithm 2: . . . .”

The LLM generates a Python function that is a novel algorithm for identifying key nodes. The platform then evaluates the generated algorithm using the uploaded network data and assesses metrics such as computational efficiency, scalability, and accuracy in identifying high-impact nodes. Using a probability, the platform may invoke a mutation phase, prompting the LLM to refine the algorithm further using a request like: “Without altering the input and output structure, modify the following algorithm to make it more effective. Provide only one Python function definition called score_nodes, without any explanation or additional text. Algorithm 1: . . . Algorithm 2: . . . .”

The modified (mutated) algorithm undergoes re-evaluation and is stored in the database with its fitness score. This iterative process continues, allowing the platform to refine its algorithms progressively.

After a number of iterations, the platform identifies the most effective algorithm based on fitness scores. The most effective algorithm, optimized through iterative comparison, generation, and mutation, is presented to the user as the final solution. The entire process is autonomous, enabling the efficient development of sophisticated algorithms for identifying key nodes in networks.

### Example #4: Polymer Design with Low/High Flammability

The platform enables the autonomous design of polymers optimized for low or high flammability. Example #4 illustrates how the platform generates novel polymer structures tailored to user-specified flammability requirements.

The process begins when a user interacts with the platform through its natural language chatbot interface. For example, the user queries: “Generate a new polymer structure with low flammability.” The platform accesses a polymer descriptor database, which includes information on twenty-six polymers. For each polymer, experimental data for specific heat at constant pressure (C_p), ignition temperature (T_i), and heat of combustion (ΔH) are used to calculate the flammability index (FI) defined by the user (FI=(C_p)(T_i)/ΔH.)

This index serves as a fitness score, with higher values indicating lower flammability. Each polymer is represented by a SMILES (Simplified Molecular Input Line Entry System) string, providing a compact description of the polymer's chemical structure. At each iteration, the platform randomly selects two polymers from the database. The better-performing polymer (e.g., the one with the higher FI) guides the generation of a new polymer structure. The platform prompts the LLM with the following request: “You have two polymers, as below. Polymer 2 has lower flammability. Please design a new polymer with low flammability. Provide only a SMILES string, without any explanation or words. Polymer 1: . . . Polymer 2: . . . .”

The LLM responds with a new SMILES string representing the proposed polymer structure, which is evaluated by the platform using a pre-trained random forest model to predict the FI of the polymer based on descriptors derived from the SMILES string. The platform stores the generated polymer and the calculated FI value in the database if the new polymer exhibits improved or competitive performance.

Additionally, the platform may initiate a mutation phase with a certain probability. During this phase, the generated polymer is refined using another LLM prompt: “Modify the polymer structure to make it reasonable. Provide only a SMILE string without explanation or words.” A mutated polymer SMILES string is generated and is re-evaluated. The FI of the mutated polymer determines whether mutated polymer is retained in the database. The iterative process of generation, evaluation, and mutation continues, progressively refining the polymer designs over multiple iterations.

After a user-defined number of iterations (e.g., 100), the platform identifies the polymer with the highest FI value as the optimal solution. This polymer, having been rigorously refined and validated, is recommended to the user as the most promising candidate for low flammability.

Example #4 highlights the platform's ability to autonomously innovate in polymer design, integrating experimental data, predictive modeling, and iterative optimization. By automating the generation of polymers tailored to specific flammability requirements, the platform accelerates the discovery of materials suitable for safety-critical applications in industries such as aerospace, construction, and manufacturing.

### Miscellaneous

The platform combines advanced large language models with evolutionary algorithms to create an autonomous system for generating, refining, and optimizing solutions. Unlike prior solutions, the platform integrates user inputs, iterative optimization, and feedback loops to deliver context-aware, domain-specific outputs. This unique synergy ensures that solutions adapt dynamically to changing requirements and datasets while maintaining high quality and relevance.

The platform features a natural language chatbot interface, allowing users to articulate their requirements, upload datasets, and refine solutions without technical expertise. This accessibility broadens the platform's capability to non-technical users and professionals across various industries, empowering users to leverage sophisticated technologies through a simple, intuitive interface. In general, the platform not only improves upon prior solutions but also makes advanced technologies more accessible to a broader audience, facilitating innovation across disciplines.

Moreover, the platform incorporates a real-time feedback loop that enables users to evaluate outputs and provide input for refinement. This feedback is integrated into the solution generation process, ensuring that outputs are not only technically robust but also aligned with user expectations. The automated evolutionary algorithm further optimizes solutions iteratively, reducing manual intervention and maintaining alignment with user-defined goals over time. These features collectively enhance adaptability, precision, and user satisfaction.

Thus, the platform does not fine tune existing models, as do current solutions but does create new models based on an evolutionary process. Said another way, unlike existing solutions, the platform is designed to generate entirely new, novel solutions or algorithms that are specifically tailored to the user's unique problem.

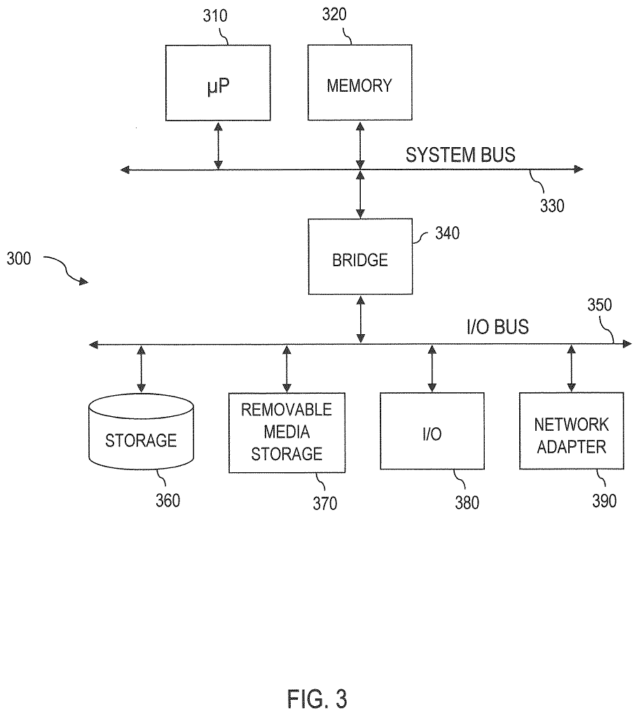

Referring to FIG. 3, a block diagram of a data processing system (i.e., computer system) is depicted in accordance with the present disclosure. Data processing system 300 may comprise a symmetric multiprocessor (SMP) system or other configuration including a plurality of processors 310 connected to system bus 330. Alternatively, a single processor 310 may be employed. Also connected to system bus 330 is local memory 320. An I/O bus bridge 340 is connected to the system bus 330 and provides an interface to an I/O bus 350. The I/O bus may be utilized to support one or more buses and corresponding devices 370, such as storage 360, removable media storage 370, input output devices (I/O devices) 380, network adapters 390, etc. Network adapters may also be coupled to the system to enable the data processing system to become coupled to other data processing systems or remote printers or storage devices through intervening private or public networks.

Also connected to the I/O bus may be devices such as a graphics adapter, storage and a computer usable storage medium having computer usable program code embodied thereon. The computer usable program code may be executed to implement any aspect of the present disclosure, for example, to implement any aspect of any of the methods and/or system components described herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using an Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A process for determining a novel solution to an issue requested by a user, the process comprising:
receiving a request for a solution to a problem identified in the request, wherein the request is received via a user interface;
receiving training data corresponding to the problem identified in the request, wherein the training data is received via a user interface;
performing until a stopping condition is met:
creating a prompt for a large language model to generate a solution based at least one the request and initial solutions;
generating a solution based on the prompt;
evaluating a performance of the generated solution;
deciding, with a predefined probability, whether to generate a prompt for the large language model to mutate the generated solution;
if the decision is to prompt for mutation:
mutating the generated solution to create a mutated solution based on the prompt;
evaluating the mutated solution; and
storing the mutated solution;
if the decision is not to prompt for mutation, storing the generated solution
determining if stopping condition is met;
determining a best solution from the stored solutions; and
presenting the best solution to the user via the user interface.

2. The process of claim 1, wherein the user interface is a chatbot.

3. The process of claim 1, wherein receiving a request further includes receiving an initial solution corresponding to the problem identified in the request.

4. The process of claim 3, wherein receiving an initial solution corresponding to the problem identified in the request further includes receiving an initial model corresponding to the problem identified in the request.

5. The process of claim 1, wherein creating a prompt includes accessing a library of solutions.

6. The process of claim 1, wherein creating a prompt includes comprises using an initial solution from data supplied by the user.

7. The process of claim 1, wherein the stopping condition includes a predetermined number of iterations.

8. The process of claim 1, wherein the stopping condition includes a number of iterations set by the user.
